(19) United States
(12) Patent Application Publication
(10) Pub. No.: US 2009/0053006 A1
(43) Pub. Date: Feb. 26, 2009

(54) BLIND FASTENER AND NOSE ASSEMBLY FOR INSTALLATION THEREOF

(75) Inventors: Gerhart Hufnagl, Tucson, AZ (US); Luke Haylock, Culver City, CA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA GLOBAL FASTENERS, INC., Torrance, CA (US)

(21) Appl. No.: 11/841,822

(22) Filed: Aug. 20, 2007

(51) Int. Cl. F16B 13/04

(52) U.S. Cl. 411/34; 411/37; 81/436

(57) ABSTRACT

A blind fastener for securing a plurality of workpieces is disclosed. The blind fastener comprises several components, a core bolt, a body sleeve member and a buckle sleeve member. The core bolt includes a tool engaging portion to engage the head of a driver on a installation tool. The buckle sleeve member has a buckle portion designed to create a bulb fastening the workpieces together. In some embodiments, a the buckle portion is locally annealed to promote formation of a blind side bulb. A nose assembly with a matching anti-rotation engagement to the head of the body sleeve member is also disclosed.

### BACKGROUND

1. Field

A blind fastener and associated methods of installation for securing a plurality of workpieces is disclosed. More particularly, a blind fastener comprising a core bolt, body sleeve member, and buckle sleeve member is disclosed.

2. General Background

Blind fasteners are commonly used to secure workpieces together when it is otherwise impossible to access the blind side of one of the workpieces. The workpiece that is accessible by an end-user is referred to as the accessible side workpiece and the workpiece that is inaccessible by an end-user is referred to as the blind side workpiece.

Blind fasteners have wide application in the aerospace industry. In aerospace applications, the blind fastener assembly of the present invention can be used to secure workpieces made of aluminum alloy, other metallic alloys, composites or any combinations thereof.

There are currently many types of blind fasteners that are utilized in the aerospace industry. Some of these fasteners are inefficient and expensive to manufacture. Additionally, there is always a need to limit the weight of the products used in the aerospace industry.

Thus, there is a need to provide a blind fastener that is compatible with a larger variety of materials. Additionally, there is a need to provide a fastener that increases the efficiency and cost effectiveness of manufacturing of blind fasteners.

### SUMMARY

In one aspect of the present disclosure, a blind fastener assembly for securing a plurality of workpieces having at least an accessible side workpiece and a blind side workpiece is disclosed. The blind fastener is comprised of a core bolt, a body sleeve member, and buckle sleeve member is disclosed.

In exemplary aspect, the core bolt has an elongated shank having a cylindrical shank portion and a threaded portion At one end of the core bolt there is an enlarged head adjacent the cylindrical shank portion. A tool engaging portion adjacent the enlarged head is included on the core bolt connected at a breakneck groove between the enlarged head and the tool engaging portion. In some exemplary embodiments, the tool engaging portion comprises a helically splined head for engagement with a matching splined driver of an installation tool.

In other aspects, the hollow cylindrical body sleeve member is adapted to fit over the elongated shank portion of the core bolt. The body sleeve member has an accessible side edge with an anti-rotation pattern designed to be engaged by a nose of an installation tool, and a tapered blind side edge. In exemplary embodiments, the anti-rotation pattern on the sleeve comprises a plurality of recesses disposed in a generally circular pattern.

In another aspect, the buckle sleeve member has a threaded inner portion at its outer edge and a buckle portion at the other edge. A smooth internal sleeve portion extends between the buckle portion and the threaded inner portion.

In another aspect, the buckle portion of the buckle sleeve member adjacent to the blind side workpiece is deformed into a bulb to secure the plurality of workpieces in response to a rotational force applied to the fastener core bolt. In another embodiment, the buckle portion of the sleeve is locally annealed to facilitate formation of the bulb.

In other exemplary embodiments, the buckle portion of the buckle sleeve member has a reduced wall thickness relative to the thickness of the threaded portion of the buckle sleeve member. In another embodiment, the smooth portion of the buckle sleeve member is stepped to provide a thinner wall thickness the sleeve from the threaded portion to the portion of the sleeve adjacent to the blind side workpiece to facilitate formation of the bulb.

In another aspect, the body sleeve portion is connected to the buckle sleeve portion with an anti-rotation feature. In an exemplary embodiment, a lead in portion on the buckle sleeve member for engagement with the tapered blind side edge of the body sleeve member. The tapered blind side edge may have a plurality of knurls to prevent rotation of the body sleeve member with respect to the buckle sleeve member.

In another aspect, a nylon insert present in the buckle portion of the buckle sleeve member helps to facilitate formation of the blind side bulb.

In another aspect, the body sleeve portion and the buckle sleeve portion are constructed of different materials. In other embodiments, the body sleeve portion and the buckle sleeve portion are constructed of a single material. In exemplary embodiments, the material of the body sleeve is Titanium.

In a further aspect, a plurality of dimples disposed on the body of the buckle sleeve member to lock a portion of the buckle sleeve member to the core bolt.

In another aspect, a nose assembly for an installation tool in combination with the blind fastener is disclosed. At one end of the nose assembly there is a matching rotational engagement that engages the rotational engagement disposed the body sleeve member. The other end of the nose assembly is adapted to be secured to the installation tool.

The installation tool as a driver with an internal bore, one end of the driver with a portion of the internal bore having splines disposed therein that engage the splined head of the core bolt member to facilitate threading of the core bolt with the buckle sleeve in response the relative rotational force applied to the fastener with the driver, and the other end of the driver being adapted to be secured to the installation tool, the driver being disposed within the internal bore of the nose assembly and rotatably movable within the bore relative to the nose assembly.

In an exemplary embodiment, the combined nose assembly has a matching rotational engagement that does not cam out of the recesses and holds the body sleeve member stationary during actuation of the installation tool.

Other objects, features, and advantages of the present disclosure will become apparent from the subsequent description and the appended claims.

### DRAWINGS

The foregoing aspects and advantages of present disclosure will become more readily apparent and understood with reference to the following detailed description, when taken in conjunction with the accompanying drawings, wherein:

FIG. 1 is a partial cross-sectional view of the fastener showing the components of the fastener after the fastener has been inserted through aligned openings in a plurality of workpieces;

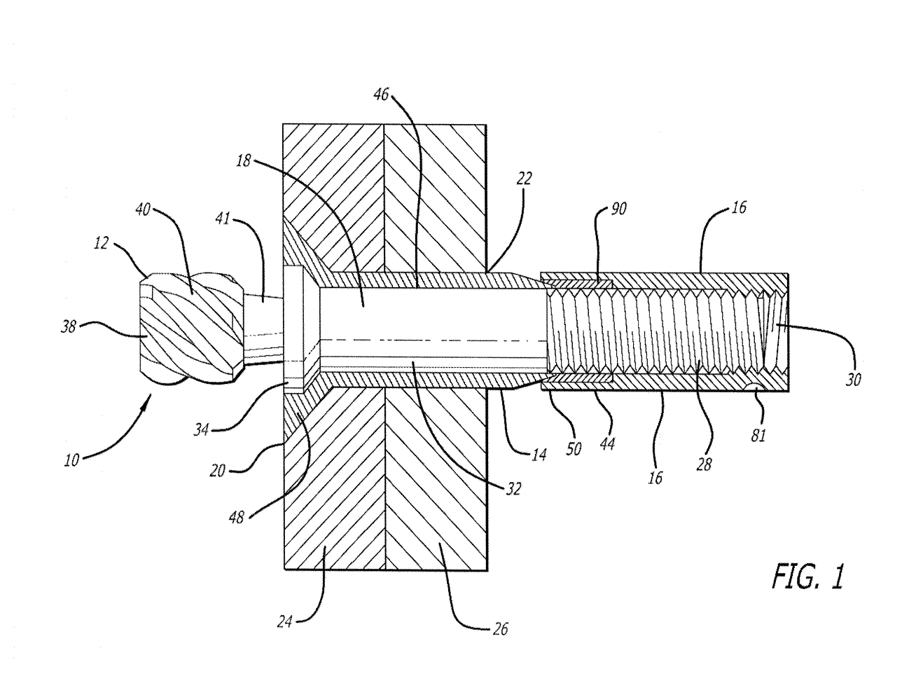

FIG. 2 is a partial cross-sectional exploded view of the fastener showing the components of the fastener;

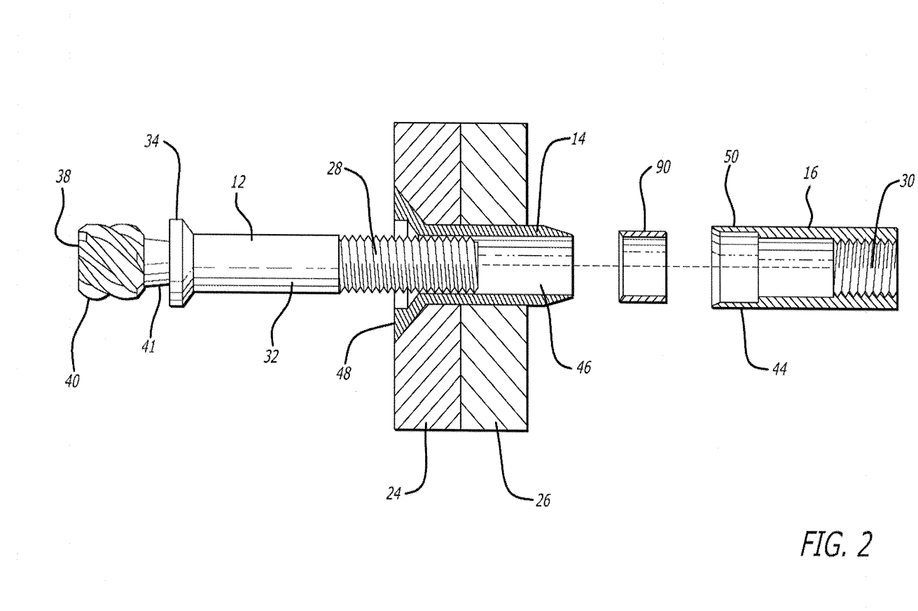

FIG. 3a-3f illustrate a partial cross-sectional view and an isometric views of the sleeve portion;

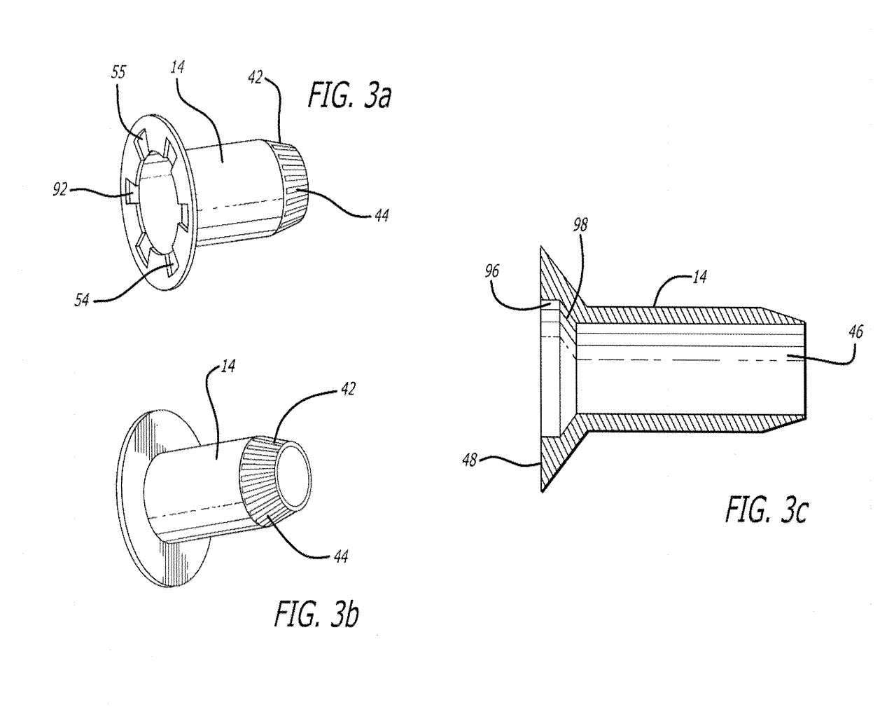

FIG. 4 is a view of the core bolt of the present disclosure;

FIG. 5 is a view of the buckle sleeve and the nylon insert of the present disclosure;

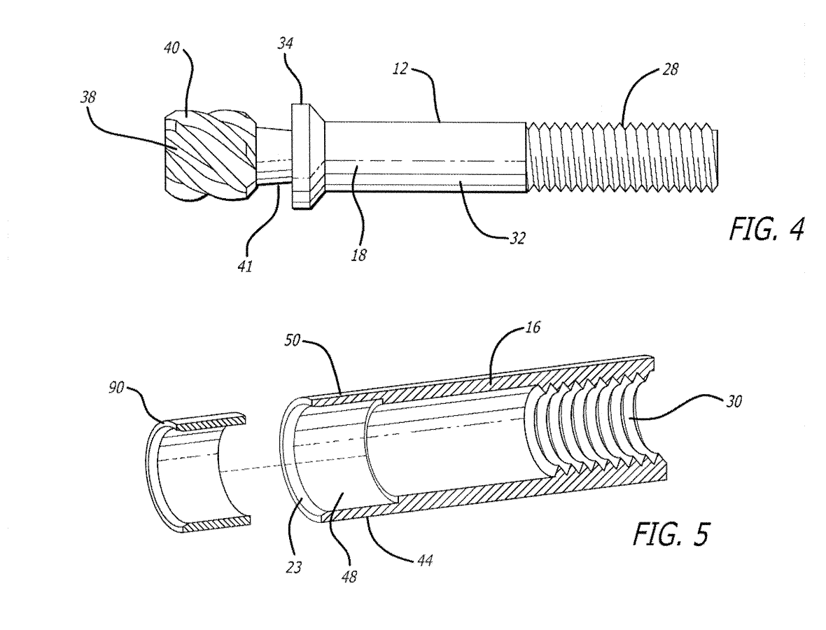

FIG. 6 is a partial cross-sectional view of the fastener showing the components of the fastener after the fastener has been inserted through aligned openings in a plurality of workpieces and has been installed; and

FIG. 7 is a partial cross-sectional view of the fastener and nose assembly of showing the components of the fastener and the nose assembly engaged with the fastener after the fastener has been inserted through aligned openings in a plurality of workpieces.

### DETAILED DESCRIPTION

A blind fastener 10 is disclosed to secure a plurality of workpieces having an accessible side workpiece and a blind side workpiece. The blind fastener 10 is comprised at least a core bolt 12, a body sleeve member 14 and a buckle sleeve member 16.

The core bolt 12 of the fastener 10 has an elongated shank 18 which extends through aligned openings 20 and 22 in the pair of workpieces, an accessible side workpiece 24 and a blind side workpiece 26, to be secured together. The elongated shank has a smooth shank portion 32 and a threaded portion 28 at one end of shank. The threaded portion 28 of the shank 18 has a diameter that is similar to the diameter smooth portion 32 of the shank 18 adjacent to the threaded portion 28. The core bolt 12 is provided with a head 34 adjacent to the smooth portion 32.

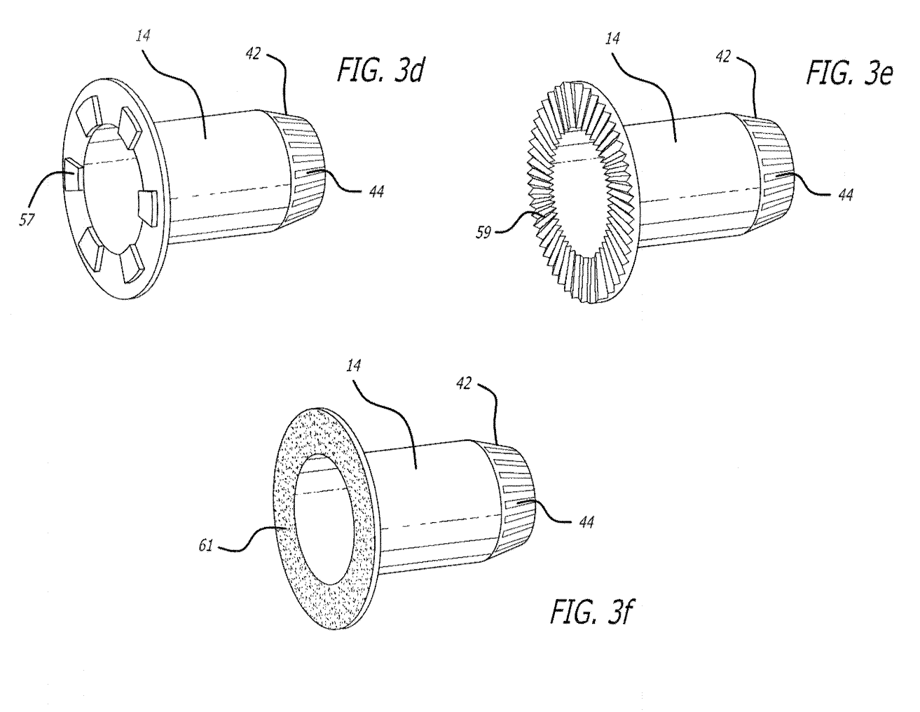

Various configurations may be utilized for the head 34 of the core bolt 12. As shown in FIG. 4, the head of the core bolt includes a tapered portion and a protruding head. In other embodiments, the head 34 may be frusto-conical and countersunk into the head of the body sleeve 14.

Adjacent to the head 34 and also forming a portion of the core bolt 12 is tool engaging portion 38 having splines or threads 40 that are engageable by a suitable driver attached to an installation tool. Between the head 34 and the tool engaging portion 38 is a breakneck groove 41 that defines the weakest point of the core bolt 12 that is adapted to fracture in torsional shear in response to the rotational force applied to head 38 of the fastener 10 during installation. Thereby, the core bolt 12 is provided with a flush configuration relative to the accessible side workpiece after the fastener 10 has been installed.

In exemplary embodiments, the body sleeve member 14 has a cylindrical shape with a smooth exterior surface that has a slight clearance fit with the aligned holes of the workpieces 24 and 26. The body sleeve member 14 has an axial through bore for receiving the core bolt 12. At one end of the body sleeve member 14 is a head 48 and at the other end is a tapered blind side end 42 having a knurled outer surface 44. The knurled outer surface 44 of the body sleeve member 14 maintains contact with buckle sleeve member 16 and prevents rotation of both during installation.

The outer end of the head portion of the body sleeve member 14 has anti-rotation pattern 54 disposed therein adapted to receive a corresponding anti-rotation pattern portion of the nose 58 of an installation tool. The anti-rotation engagement 54 interacts and engages with a corresponding anti-rotation pattern on the nose of an installation tool to prevent rotation of the body sleeve member 14 during installation of the blind fastener 10.

The body sleeve member 14 has an annular, outwardly facing, seat 36 at the outer end of the body sleeve member 14 adapted to receive the head 34 of the core bolt 12. In the particular construction illustrated, the head 34 is frustoconical and the seat 36 is complementarily so that the core bolt 12 is countersunk into the sleeve 14. The seat 36 has a cylindrical portion matching the protruding head of the core bolt 12 and a pocket recess 96 that is tapered 98 to match the tapered portion of the head of the core bolt 12. Other conventional head types for bolts and sleeves may also be utilized.

The buckle sleeve member 16 has an internally threaded portion 30 at the outer or blind side end of the buckle sleeve member 16 that is adapted to threadably engage the threaded portion 28 of the core bolt 12. Adjacent to the threaded portion 30 is an internal smooth portion 17 extending to a lead-in tapered portion 23 at the end of the buckle sleeve member 16. The threaded portion 30 has a greater thickness than the internal smooth portion 17 of the buckle sleeve member 16. In one exemplary embodiment, the thickness of the smooth portion is stepped 48 at a location 50 adjacent to the outside the blind side workpiece 26, providing a buckle area for the buckle sleeve member 16. At such location 50, the wall thickness of the buckle portion of the buckle sleeve member 16 remains substantially the same until reaching the lead-in tapered portion 23 of the sleeve 14.

The buckle portion 44 of the buckle sleeve member 16 is locally annealed to facilitate formation of the bulb 52. The buckle portion 44 of the buckle sleeve member 16 is treated with heat that alters the structure of a material causing lower strength and hardness in that area. In an exemplary embodiment, the buckle portion 44 of the buckle sleeve member 16 is locally annealed through induction by placing the buckle portion in a heating coil for about 3 seconds. As a result of the lower strength, the buckle portion 44 of the buckle sleeve member 16 deforms into a bulb 52 during installation.

In another embodiment, the buckle sleeve member 16 could be fully annealed, In this embodiment, the buckle sleeve member 16 has a longer threaded portion 30 to compensate for reduction the thread strength resulting from the annealing process.

In other exemplary embodiments, the stepped buckle portion 48 having a thinner wall thickness facilitates bulb 52 formation against the blind side workpiece 26 in substantially all grip ranges of the fastener 10. In other embodiments, the buckle portion 44 of the buckle sleeve member 16 has a reduced wall thickness relative to the thickness of the smooth portion 17 of the buckle sleeve member 16.

In exemplary embodiments, a nylon insert 90 is inserted into the buckle area 44 of the buckle sleeve member 16. In exemplary embodiments, the nylon insert 90 helps to facilitate initiating the formation of the blind side bulb 52.

The buckle sleeve member 16 may further comprise a lead in portion 23 at the head of buckle sleeve member 16. The knurled portion 44 of the body sleeve member 14 engages the lead in portion 23 to connect the body sleeve member to the buckle sleeve member.

In one exemplary embodiment, the anti-rotation engagement pattern 54 in the head of the body sleeve member 14 comprises a plurality of recesses formed in the head of the sleeve. Preferably, the recesses 55 slope rearwardly toward the blind side workpiece 26 and are relatively shallow. The relatively shallow construction of the recesses 55 does not significantly weaken the sleeve 14 of the present disclosure like the deep recesses used in prior art blind fasteners. The plurality of recesses 55 are disposed in the head 42 of the sleeve 14 in a generally circular orientation. The circular orientation is particularly advantageous in that the circular orientation does not weaken the head 42 by using cross recesses. Alternatively, the recesses 55 can be formed in any configuration that allows the head 42 of the sleeve 14 to be engaged with the matching anti-rotation engagement 56. For example, the recesses 55 could be in the orientation of a hexagon, a square, a cross-slot configuration, or a single slot configuration as long as the matching anti-rotation engagement 56 of the nose 58 have a matching configuration.

In other embodiments, there is a plurality of projections 57 formed on the head of the body sleeve member 14 to be engaged with a plurality of recesses in the nose of the tool 60. In other embodiments, a radial set of sloped surfaces 59 could be utilized to prevent rotation of the body sleeve member 14. In still other embodiments, the pattern could be a frictional starburst or stippled pattern 61 on the head of the body sleeve member 14. Any frictional anti-rotation pattern 54 that interacts and engages with a corresponding anti-rotation element on the nose of an installation tool 60 to prevent rotation of the body sleeve member 14 during installation of the blind fastener may be utilized.

As depicted in the figures, the blind fastener 10 has no threaded portion in the shear plane area, which comprises the area through the plurality of workpieces 24, 26 having at least an accessible side workpiece and a blind side workpiece. Thus, a structural blind fastener 10 with full shear strength capability is provided, as if it were a solid shank fastener and provides a stronger fastener. Additionally, the blind fastener provides a high level of joint preload.

To install the fastener, the blind fastener 10 must first be assembled. First, the multiple portions of the sleeve are placed together. Then, the core bolt is threadably engaged with the portion of the buckle sleeve member 16 that is threaded. To prepare the fastener for installation, the body of the buckle sleeve member 16 then is dimpled wherein a small portion of an outer surface of the body of the buckle sleeve member 16 is physically deformed against the core bolt 12. The dimpling 81 results in a small portion of the buckle sleeve member 16 material being displaced against the core bolt 12 to cause sufficient engagement to prevent loosening of the core bolt 12 from vibration after installation. In exemplary embodiments, the dimpling 81 is performed on the exterior surface of the buckle sleeve adjacent to that portion of the buckle sleeve member 16 that is threadably engaged with the core bolt 12.

The assembled fastener 10 is then utilized to secure a plurality of workpieces 24 and 26 together. The fastener 10 is inserted through aligned openings 20 and 22 in the workpieces 24 and 26 wherein the head 42 of the sleeve 14 sits against the outer surface of the accessible side workpiece 24, and a portion of the threaded portion 30 of the sleeve 14 extends out from the workpiece 26 and is adjacent to the outer surface of the blind side workpiece 26.

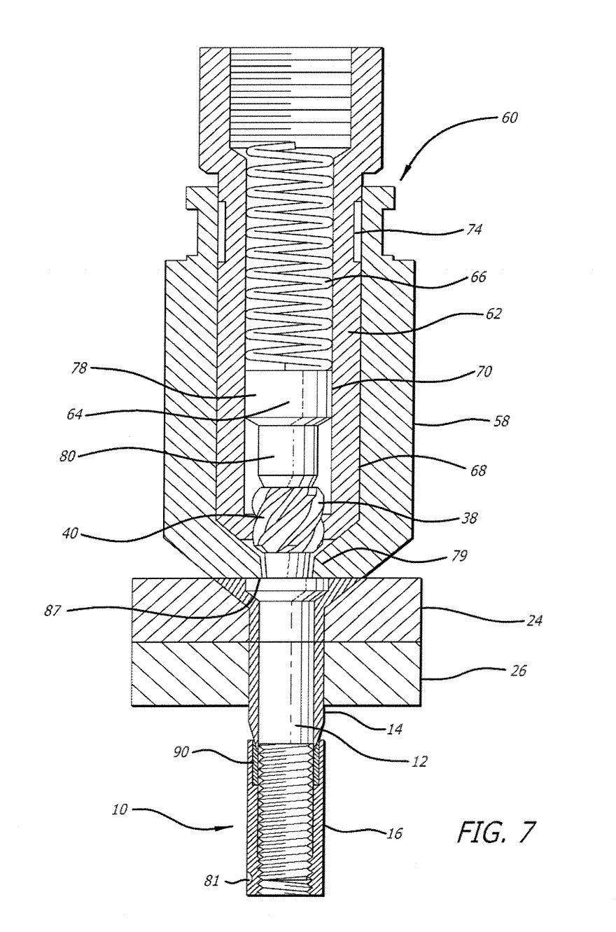

A rotary installation tool with nose assembly 60 is provided to set the fastener 10. The splines or threads 40 of the core bolt 12 are engaged with the complementary splines or threads 72 of the driver 62. Upon actuation of the tool, the driver 62 is rotatably driven within the bore 68 of the nose 58 while the nose 58 is held stationary relative to the driver 62. The splined engagement between the core bolt 12 and nose assembly 60 simultaneously pulls the nose assembly towards the fastener 10 during actuation of the tool to ensure proper engagement of the matching anti-rotation engagement 56 with the recesses 54 and rotatably torques the core bolt 12 to effectively form the bulb 52 of the fastener 10. Relative axial movement of head 38 pushes ejector 64 within the internal bore 70 of the driver 62 that does not have splines and compresses spring 66 as shown in FIG. 7. As the core bolt 12 is rotatably torqued and a relative axial force is applied to the nose assembly 60 during actuation of the installation tool, the matching anti-rotation engagement 56 of the nose 58 engage the anti-rotation engagement portion 54 of the sleeve 14 which prevents the sleeve 14 from rotating relative to the nose 58 since the nose 58 is held stationary relative to the rotatably driven driver 62. Additionally, the matching anti-rotation engagement 56 and nose 58 towards the blind side workpiece 26 prevents the nose 58 from camming out of the anti-rotation engagement portion 54 during the installation of the fastener 10.

As the installation tool rotates the core bolt 12 and holds the body sleeve member 14 and buckle sleeve member 16 stationary, it is significant to note that there is no abrading or scratching of the head 42 of the sleeve 14 by the matching anti-rotation engagement 56 of the nose 58. Due to the engagement that is maintained between the frictional engagement during installation of the fastener 10, no slipping of the body sleeve member 14 relative to the nose 58 can occur. This provides consistent and predictable results and no slipping between the body sleeve member 14 and the nose 58 due to cam-outs.

The installation load applied by the installation tool results in the core bolt 12 being further threaded with the buckle sleeve member 16 while deforming that portion of the buckle sleeve member 16 that is of a reduced wall thickness relative to the threaded portion 30 of the buckle sleeve member 16 that is adjacent to an outer surface of the blind side workpiece 26 to form the bulb 52 as shown in FIG. 7. When the bulb 52 is fully formed, further rotation of the core bolt 12 stops. In exemplary embodiments, the blind side bulb has a diameter 1.5 times greater than the shank diameter. The nylon insert 90 also becomes a portion of the bulb 52.

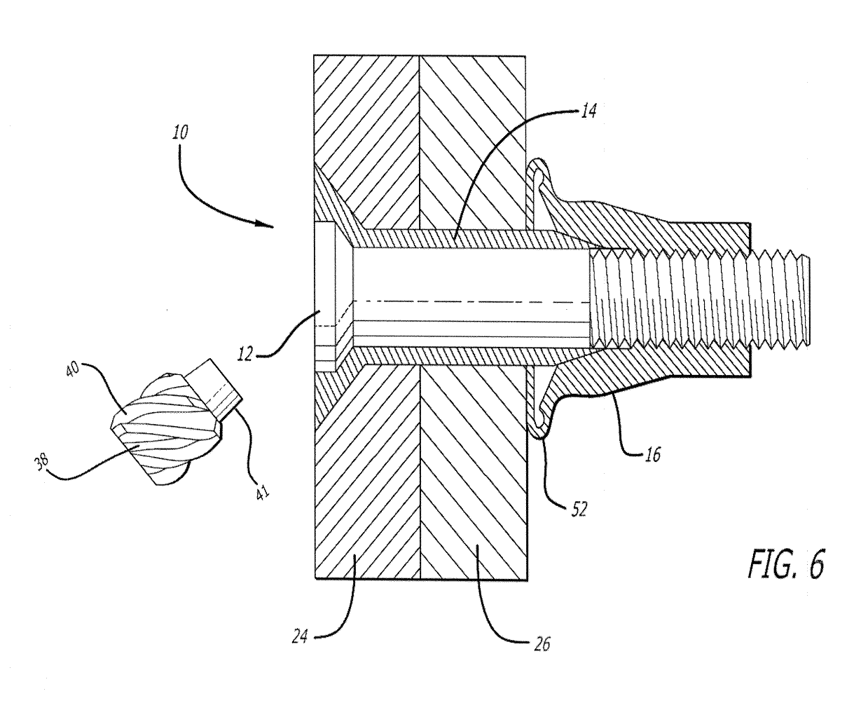

At this point, torsional load builds up in the core bolt 12 and the breakneck groove 41 will fracture in torsional shear and break away along with the head 38 as shown in FIG. 6. At this point, the spring 66 applies force against ejector 64 which ejects the severed head 38 from the nose assembly 60. Since the first diameter portion 78 has a diameter greater than the diameter of the internal bore 70 that has splines 72 disposed thereon, the ejector 64 remains within the internal bore 70 after the fastener 10 has been set. As shown in the FIG. 6, the head 38 breaks away from the core bolt 12 without any damage to the head 42.

The installation tool utilizes a breakneck cutter 79 having a 50 cutter angle and a sharp point 87. The sharp point 87 of the cutter triggers the fracture surface. Traditionally radius cutters are used as the cutter, which results in a 0.005″ to 0.020″ high break surface. In contrast, the installation tool of the present disclosure results in the remaining portion of the core bolt 12 is substantially flush with the outer surface of the head 42 of the body sleeve member 14.

The blind fastener and tool system of the present disclosure are compatible and very user friendly installation tool system. The nose and body sleeve member require no rotational tool alignment and automatically forces positive tool engagement without the risk of tool cam-out and associated malfunctions. In addition to manual installation, a robot friendly fastening system may be utilized to install the fastener.

By providing a fastener having multiple components, the fastener is more versatile. The materials for the separate components may be comprised of different materials. This leads to a more versatile fastener that is compatible for working with workpieces of different materials, including composites, titanium and other materials.

In some embodiments, the core bolt may be constructed from titanium and the body sleeve member and buckle sleeve member may be constructed of A-286 nickel alloy. In still other embodiments, the buckle sleeve member of the fastener may be constructed of commercially pure titanium. In this embodiment, use of commercially pure titanium provides a larger bulb diameter. In still other exemplary embodiments, the blind fastener may be constructed entirely with titanium. Utilization of titanium to produce the entire fastener provides a lighter weight fastener that may be widely utilized in the aerospace industry.

While the above description contains many particulars, these should not be considered limitations on the scope of the disclosure, but rather a demonstration of embodiments thereof. The blind fastener and uses disclosed herein include any combination of the different species or embodiments disclosed. Accordingly, it is not intended that the scope of the disclosure in any way be limited by the above description. The various elements of the claims and claims themselves may be combined any combination, in accordance with the teachings of the present disclosure, which includes the claims.

1. A blind fastener assembly for securing a plurality of workpieces having at least an accessible side workpiece and a blind side workpiece comprising:
a core bolt, the core bolt having an elongated shank, the elongated shank having a cylindrical shank portion and a threaded portion, the core bolt having an enlarged head adjacent the smooth shank portion and a tool engaging portion adjacent the enlarged head, the core bolt having a breakneck groove between the enlarged head and the tool engaging portion;
a hollow body sleeve member adapted to fit over the elongated shank portion of the core bolt, the body sleeve member having an accessible side edge with a anti-rotation engagement to be engaged by a nose of an installation tool, the body sleeve member having a tapered blind side edge;
a buckle sleeve member having a buckle portion at one end and an internally threaded portion at it other end, the buckle portion being locally annealed; and
wherein the external thread of the core bolt engages the internal thread of the buckle sleeve, thereby forcing formation of a blind side bulb adjacent the blind side work piece in response to rotation of the core bolt member during installation.

2. The blind fastener assembly of claim 1 further comprising a lead in portion on the buckle sleeve member for engagement with the tapered blind side edge of the body sleeve member.

3. The blind fastener assembly of claim 1 further comprising a nylon insert in the buckle portion for the purpose of initiating the formation of the blind side bulb.

4. The blind fastener assembly of claim 1 wherein the body sleeve portion and the buckle sleeve portion are constructed of different materials.

5. The blind fastener assembly of claim 1 wherein the body sleeve portion and the buckle sleeve portion are constructed of a single material.

6. The blind fastener assembly of claim 4 wherein the material is titanium.

7. The blind fastener assembly of claim 1 wherein a buckle portion of the buckle sleeve member has a reduced wall thickness relative to the thickness of the threaded portion of the buckle sleeve member.

8. The blind fastener assembly of claim 1 wherein the buckle portion of the buckle sleeve member is locally induction annealed to facilitate the formation of the bulb.

9. The blind fastener assembly of claim 1 wherein the smooth portion of the buckle sleeve member is stepped to provide a reduced wall thickness to facilitate the formation of the blind side bulb.

10. The blind fastener assembly of claim 1 wherein the tapered blind side edge has a plurality of knurls to prevent rotation of the buckle sleeve member with respect to the body sleeve member.

11. The blind fastener assembly of claim 1 further comprising a plurality of dimples disposed on the threaded area of the buckle sleeve member to provide a friction lock between the thread of the of the buckle sleeve member and the thread of the core bolt, thus preventing disassembly in service.

12. The blind fastener of claim 1 wherein the tool engaging portion of the core bolt comprises a helically splined head for engagement with a spline driver of an installation tool.

13. The blind fastener of claim 1 wherein the anti-rotation engagement on the sleeve comprises a plurality of recesses disposed in a generally circular pattern.

14. The blind fastener of claim 1 wherein the anti-rotation engagement on the sleeve comprises a plurality of projections disposed in a generally circular pattern.

15. The blind fastener of claim 1 wherein the anti-rotation engagement on the sleeve comprises a stippled pattern disposed in a generally circular pattern.

16. The blind fastener of claim 1 wherein the anti-rotation engagement on the sleeve comprises a starburst pattern disposed in a generally circular pattern.

17. The blind fastener of claim 1 wherein the breakneck groove is adapted to fracture in torsional shear in response to the relative rotational force applied to the fastener with a splined driver engaging the splined head that facilitates threading of the threads of the core bolt member with the threads of the sleeve during actuation of the installation tool secured to the splined driver.

18. The blind fastener of claim 1 wherein the blind side bulb has a diameter about 1.5 times greater than the shank diameter.

19. The blind fastener of claim 1 having full shear strength capability wherein there are no threads in the plane shear area.

20. The blind fastener of claim 1 wherein the installation tool utilizes a breakneck cutter having a 5°cutter angle

21. A blind fastener assembly for securing a plurality of workpieces having at least an accessible side workpiece and a blind side workpiece comprising:
a core bolt, the core bolt having an elongated shank, the elongated shank having a cylindrical shank portion and a threaded portion, the core bolt having an enlarged head adjacent the smooth shank portion and a tool engaging portion adjacent the enlarged head, the core bolt having a breakneck groove between the enlarged head and the tool engaging portion;
a hollow body sleeve member adapted to fit over the elongated shank portion of the core bolt, the body sleeve member having an accessible side edge with a anti-rotation engagement to be engaged by a nose of an installation tool, the body sleeve member having a tapered blind side edge;
a buckle sleeve member having a buckle portion at one end and an internally threaded portion at it other end, wherein the entire buckle sleeve member is fully annealed and has a long threaded portion; and
wherein the external thread of the core bolt engages the internal thread of the buckle sleeve, thereby forcing formation of a blind side bulb adjacent the blind side work piece in response to rotation of the core bolt member during installation.

22. The blind fastener assembly of claim 21 further comprising a lead in portion on the buckle sleeve member for engagement with the tapered blind side edge of the body sleeve member.

23. The blind fastener assembly of claim 21 further comprising a nylon insert in the buckle portion for the purpose of initiating the formation of the blind side bulb.

24. The blind fastener assembly of claim 21 wherein the body sleeve portion and the buckle sleeve portion are constructed of different materials.

25. The blind fastener assembly of claim 21 wherein the body sleeve portion and the buckle sleeve portion are constructed of a single material.

26. The blind fastener assembly of claim 25 wherein the material is titanium.

27. The blind fastener assembly of claim 21 wherein a buckle portion of the buckle sleeve member has a reduced wall thickness relative to the thickness of the threaded portion of the buckle sleeve member.

28. The blind fastener assembly of claim 21 wherein the buckle portion of the buckle sleeve member is locally induction annealed to facilitate the formation of the bulb.

29. The blind fastener assembly of claim 21 wherein the smooth portion of the buckle sleeve member is stepped to provide a reduced wall thickness to facilitate the formation of the blind side bulb.

30. The blind fastener assembly of claim 21 wherein the tapered blind side edge has a plurality of knurls to prevent rotation of the buckle sleeve member with respect to the body sleeve member.

31. The blind fastener assembly of claim 21 further comprising a plurality of dimples disposed on the threaded area of the buckle sleeve member to provide a friction lock between the thread of the of the buckle sleeve member and the thread of the core bolt, thus preventing disassembly in service.

32. The blind fastener of claim 21 wherein the tool engaging portion of the core bolt comprises a helically splined head for engagement with a spline driver of an installation tool.

33. The blind fastener of claim 21 wherein the anti-rotation engagement on the sleeve comprises a plurality of recesses disposed in a generally circular pattern.

34. The blind fastener of claim 21 wherein the anti-rotation engagement on the sleeve comprises a plurality of projections disposed in a generally circular pattern.

35. The blind fastener of claim 21 wherein the anti-rotation engagement on the sleeve comprises a stippled pattern disposed in a generally circular pattern.

36. The blind fastener of claim 21 wherein the anti-rotation engagement on the sleeve comprises a starburst pattern disposed in a generally circular pattern.

37. The blind fastener of claim 21 wherein the breakneck groove is adapted to fracture in torsional shear in response to the relative rotational force applied to the fastener with a splined driver engaging the splined head that facilitates threading of the threads of the core bolt member with the threads of the sleeve during actuation of the installation tool secured to the splined driver.

38. The blind fastener of claim 21 wherein the blind side bulb has a diameter about 1.5 times greater than the shank diameter.

39. The blind fastener of claim 21 having full shear strength capability wherein there are no threads in the plane shear area.

40. The blind fastener of claim 21 wherein the installation tool utilizes a breakneck cutter having a 5°cutter angle

41. The blind fastener of claim 21 wherein the entire buckle sleeve member is fully annealed and has a longer threaded portion.

42. A blind fastener in combination with a nose assembly secured to an installation tool for securing a plurality of workpieces together, the combination comprising:
the blind fastener having a core bolt, the core bolt having an elongated shank, the elongated shank having a smooth shank portion and a threaded portion, the core bolt having an enlarged head adjacent the smooth shank portion and a tool engaging portion adjacent the enlarged head, the core bolt having a breakneck groove between the enlarged head and the tool engaging portion;
a cylindrical body sleeve member adapted to fit over the elongated shank portion of the core bolt, the body sleeve member having an accessible side edge with a anti-rotation engagement to engage a nose of an installation tool, the body sleeve member having a tapered blind side edge;
a buckle sleeve member having a buckle portion at one end and an internally threaded portion at its other end, the buckle portion being locally induction annealed; and
wherein the external thread of the core bolt engages the internal thread of the buckle sleeve, thereby forcing formation of a blind side bulb adjacent the blind side work piece in response to rotation of the core bolt member during installation;
the nose assembly having an internal bore, one end of the nose having a matching rotational engagement that engages the rotational engagement disposed the body sleeve member, and another end of the nose assembly being adapted to be secured to the installation tool;
and a driver having an internal bore, one end of the driver having a portion of the internal bore having splines disposed therein that engage the splined head of the core bolt to facilitate threading of the core bolt with the buckle sleeve in response the relative rational force applied to the fastener with the driver, and another end of the driver being adapted to be secured to the installation tool, the driver being disposed within the internal bore of the nose assembly and rotatably movable within the bore relative to the nose assembly; and
wherein the matching rotational engagement does not cam out of the recesses and holds the body sleeve member stationary during actuation of the installation tool.
